(19) United States
(12) Patent Application Publication
(10) Pub. No.: US 2010/0165914 A1
(43) Pub. Date: Jul. 1, 2010

(54) BEAM DIVISION MULTIPLE ACCESS SYSTEM AND METHOD FOR MOBILE COMMUNICATION SYSTEM

(76) Inventors: Dong-Ho Cho, Daejeon (KR); Woong-Sup Lee, Daejeon (KR); O-Hyun Jo, Daejeon (KR); Ho-Won Lee, Daejeon (KR); Hee-Jung Yu, Daejeon (KR); Young-Seok Oh, Daejeon (KR); Yong-Hoon Lee, Daejeon (KR)

Correspondence Address: The Belles Group, P.C., 1518 Walnut Street, Suite 1706, Philadephia, PA, 19102, US

(21) Appl. No.: 12/304,236

(22) PCT Filed: Apr. 16, 2008
(86) PCT No.: PCT/KR08/02140

§ 371 Date: Dec. 10, 2008

(51) Int. Cl. H04W 40/00

(52) U.S. Cl. 370/328

(57) ABSTRACT

The present invention is related to a beam division multiple access system and a method thereof. The base station according to the present invention comprises a initial mobile station information receiver for receiving initial mobile station information that a mobile station omnidirectionally transmits in an initial communication step, a mobile station location and speed detector for detecting a location and a moving speed of the mobile station from the initial mobile station information, a downlink beam generator for generating a downlink beam based on the location and the moving speed of the mobile station transferred from the mobile station location and speed detector, and adjusting at least one of a width and a direction of each the downlink beam, and a downlink beam transmitter for transmitting the downlink beam generated by the downlink beam generator to the mobile station through a phase array antenna.

### BACKGROUND

1. Field of the Invention

The present invention relates to multiple access technology of a mobile communication system, and more particularly to a beam division multiple access system and a method thereof, which use beamforming technology and uses multiple beamforming pattern simultaneously in a cell, allowing to give multiple access.

2. Discussion of Related Art

In a mobile communication system, communication should be achieved using limited frequency and time. In order to do this, a multiple access technique is required. There are Frequency Division Multiple Access (referred to as ‘FDMA’ hereinafter), Time Division Multiple Access (referred to as ‘TDMA’ hereinafter), Code Division Multiple Access (referred to as ‘CDMA’ hereinafter), Orthogonal Frequency Division Multiple Access (referred to as ‘OFDMA’ hereinafter) techniques, etc. as examples of typical multiple access technology developed up to now.

The FDMA technique divides frequency resource and allots them to respective mobile stations, allowing to give multiple access. The TDMA technique divides time resource, and allots respective mobile stations to give multiple access. The COMA technique allots orthogonal codes to respective mobile stations, which allows the mobile stations to give multiple access. The OFDMA technique divides and allots an orthogonal frequency resource to maximize resource utility efficiency.

In the mobile communication system, limited frequency and time are divided to be used among multiple users, and a capacity of the mobile communication system is limited depending on given frequency and time. It is expected that a capacity required in a mobile communication system will increase as the number of mobile stations increase in future and an amount of data required in respective mobile stations is increased. However, since frequency/time resources which respective systems can use are limited, there is a demand for a technical development, which uses other resources than frequency/time resources in order to increase a capacity of the system.

Meanwhile, a space division scheme has been proposed to increase the capacity of the system. Here, the space division method divides a space resource.

There is a method of using a Multiple Input Multiple Output (referred to as ‘MIMO’ hereinafter) antenna as an example of a conventionally proposed space division method. In the space division method using the MIMO antenna, a plurality of transmission antennas and a plurality of receiving antennas are mounted on a mobile station, and the mobile station uses different transmission antennas and receiving antennas to communicate. The capacity can be increased by a minimum value of the number of the antennas, which are mounted on the mobile station and the BS station.

However, since the mobile station is a portable device, the number of antennas capable of being mounted on the mobile station is limited. Accordingly, the conventional method has a problem in that it cannot increase a capacity of the system sufficiently.

There has been proposed a space division method using a parabolic antenna for satellite communication as another space division method. However, such a space division method has problems in that a base station cannot receive incoming signals from a plurality of directions at the same time due to characteristics of the parabolic antenna, and is hard to change a beam direction of the antenna adaptively.

### SUMMARY OF THE INVENTION

Accordingly, the present invention has been made to solve the above-mentioned problems. It is an object of the present invention to provide a beam division multiple access system and a method thereof for a mobile communication system as a new space division method using a phase array antenna.

In order to achieve the object, there is a beam division multiple access system in a base station of a mobile communication system, comprising: an initial mobile station information receiver for receiving initial mobile station information that a mobile station omnidirectionally transmits in an initial communication step; a mobile station location and speed detector for detecting a location and a moving speed of the mobile station from the initial mobile station information of the initial mobile station information receiver; a downlink beam generator for generating a downlink beam based on the location and the moving speed of the mobile station transferred from the mobile station location and speed detector, and adjusting at least one of a width and a direction of each downlink beam; and a downlink beam transmitter for transmitting the downlink beam generated by the downlink beam generator to the mobile station through a phase array antenna.

According to a second aspect of the present invention, there is a beam division multiple access system in a mobile station of a mobile communication system, comprising: a mobile station location and speed detector for detecting a current location and moving speed of a mobile station; an initial mobile station information transmitter for omnidirectionally transmitting initial mobile station information comprising the current location and moving speed of the mobile station to a base station; a downlink beam receiver for receiving a downlink beam from the base station; an uplink beam generator for tracking a direction of the downlink beam received by the downlink beam receiver and generating an uplink beam; and an uplink beam transmitter for transmitting the uplink beam generated by the uplink beam generator to the base station.

According to a third aspect of the present invention, there is a beam division multiple access method in a base station of a mobile communication system, comprising the steps of: (a) receiving initial mobile station information that a mobile station omnidirectionally transmits in an initial communication step; (b) detecting a location and a moving speed of the mobile station from the initial mobile station information received in the step (a); (c) generating a downlink beam based on the location and the moving speed of the mobile station detected in the step (b), and adjusting at least one of a width and a direction of each the downlink beam; and (d) transmitting the downlink beam generated in the step (c) to the mobile station through a phase array antenna.

According to another embodiment of the present invention, there is a beam division multiple access method in a mobile station of a mobile communication system, comprising the steps of: (a) detecting a current location and moving speed of a mobile station; (b) omnidirectionally transmitting initial mobile station information comprising the current location and moving speed of the mobile station to a base station; (c) receiving a downlink beam from the base station; (d) tracking a direction of the downlink beam received in the step (c) and generating an uplink beam; and (e) transmitting the uplink beam generated in the step (d) to the base station.

According to the present invention, the mobile communication system may maximize spatial use of frequency/time resources, and a system capacity of a base station by the number of beams in the base station, by efficiently dividing a space resource as well as frequency/time resources, and allotting orthogonal beams to mobile stations so that the mobile stations can give multiple access.

Further, since the present invention does not transmit omnidirectional signals, it may solve an inter-cell interference problem to solve performance deterioration problems of users at cell edge occurring in a cellular system.

Moreover, because radiation pattern of an antenna of the base station and radiation pattern of an antenna of the mobile station are designed to match each other, radiation efficiency of the antennas can be maximized.

In addition, since mobile stations existing at a similar position share one beam to communicate, a lower MCS level problem or PAPR (Peak-to-Average Power Ratio) problems of a control channel occurring because mobile stations having good channels and mobile stations having bad channels simultaneously use the same base station, can be solved.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 illustrates a concept of a BDMA technique according to the present invention;

FIG. 2 illustrates another example of a concept of the BDMA technique according to the present invention;

FIG. 3 is a timing diagram between a base station system and mobile stations which embody a BDMA technique of the present invention;

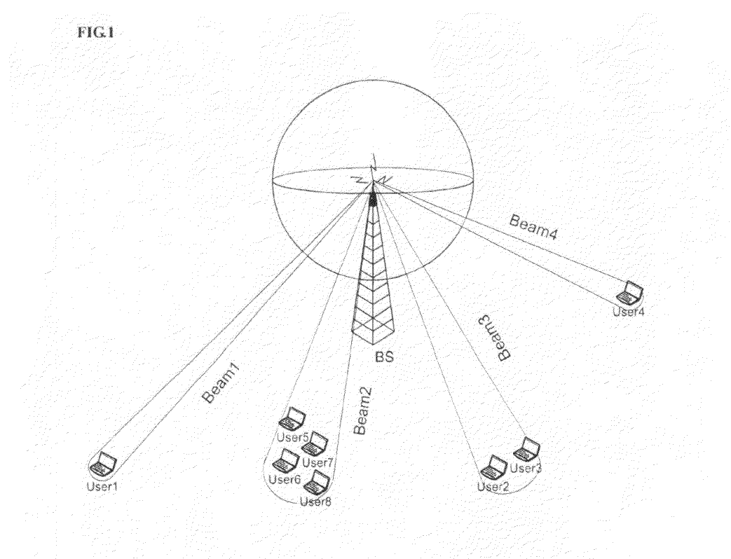

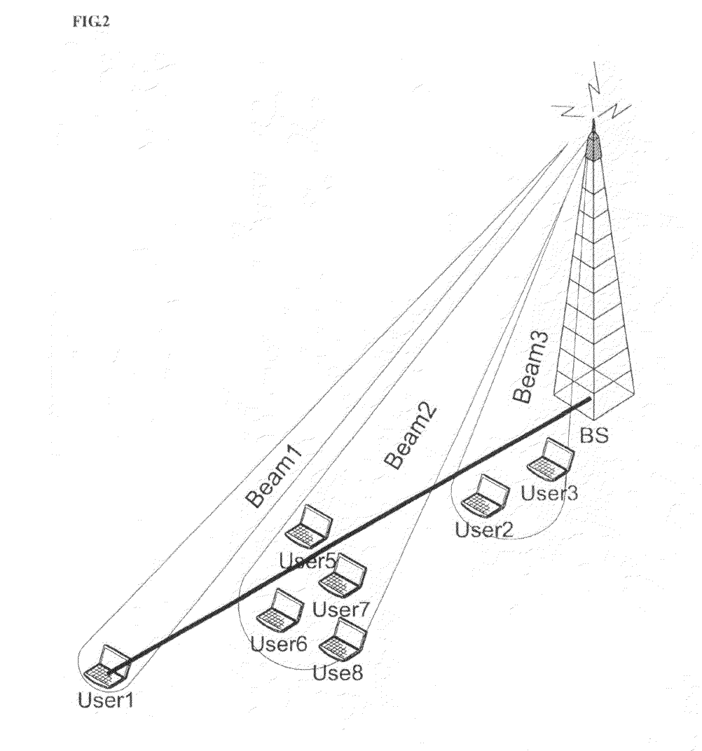

FIG. 1 is a block diagram showing a configuration of a base station system for embodying the BDMA technique according to the present invention;

FIG. 5 is a block diagram showing a construction of a mobile station for embodying the BDMA technique according to the present invention;

FIG. 6 illustrates an applied example of the beam update method according to the present invention;

FIG. 7 illustrates a frame structure for supporting a TDD-BDMA according to the present invention;

FIG. 8 to FIG. 10 illustrate applied examples of the TDD-BDMA frame of FIG. 7; and

FIG. 11 illustrates a view showing a frame structure for supporting an FDD-BDMA according to the present invention.

### DETAILED DESCRIPTION OF PREFERRED EMBODIMENTS

Hereinafter, a beam division multiple access system and a method thereof for a mobile communication system according to preferable embodiments according to the present invention will be described with reference to the accompanying drawings.

An embodiment of the present invention proposes a method of increasing a capacity of a system using location information of mobile stations in a mobile communication system, which is referred to as ‘Beam Division Multiple Access (BDMA)’. The BDMA technique of the present invention divides an antenna beam according to locations of the mobile stations to allow the mobile stations to give multiple access, thereby significantly increasing the capacity of the system.

The BDMA can be embodied by generating beams having beam patterns directing toward a special location through beam forming using a phase array antenna. Mobile stations sharing the same beams give multiple access by applying a general multiple access technique such as TDMA, TDMA, CDMA, or OEDMA.

Where mobile stations and a base station are in an LOS (Line of Sight) state, when they exactly know each other's positions, they can transmit beams which direct to each other's position to communicate without interfering with mobile stations at cell edge. If one base station can transmit orthogonal beams in a plurality of directions at the same time, a multiple access can be achieved using such orthogonal beams. In particular, in a case of a system having a smaller cell, because communication paths among most mobile stations and a base station are in the LOS state, the BDMA technique of the present invention can be easily applied thereto.

FIG. 1 illustrates a concept of a BDMA technique according to the present invention. When respective mobile stations are positioned at different angles with respect to a base station, the base station transmits beams at different angles to simultaneously transmit data to multiple mobile stations. In the same manner, mobile stations transmit beams toward the base station to transmit data thereto. One mobile station does not use one beam exclusively, but mobile stations positioned at a similar angle share one beam to communicate with the base station. The mobile stations sharing the same beam divide same frequency/time resources and use orthogonal resources. FIG. 1 shows an example in which a first user uses a first beam exclusively, a second user and a third user share a third beam, a fourth user uses a fourth beam exclusively, and fifth to eighth users share a second beam.

FIG. 2 shows another example of a concept of the BDMA technique according to the present invention.

When respective mobile stations are positioned at different directions on the same angle, the base station transmits different beams according to distances from the respective mobile stations to simultaneously transmit data to a plurality of mobile stations. FIG. 2 shows an example in which a first user uses a first beam exclusively, a second user and a third user share a third beam, and fifth to eighth users share a second beam.

Since the BDMA technique according to the present invention forms beams using a phase array antenna, a base station can change direction, the number, and widths of the beams adaptively and easily according to a mobile communication environment. Accordingly, the present invention can rapidly respond to varying mobile communication environments. Further, because respective beams can be three-dimensionally divided, a spatial reuse of frequency/time resources can be maximized.

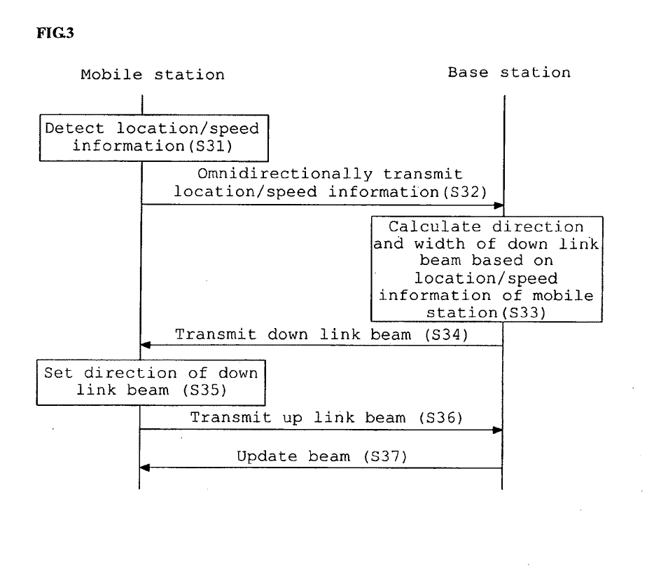

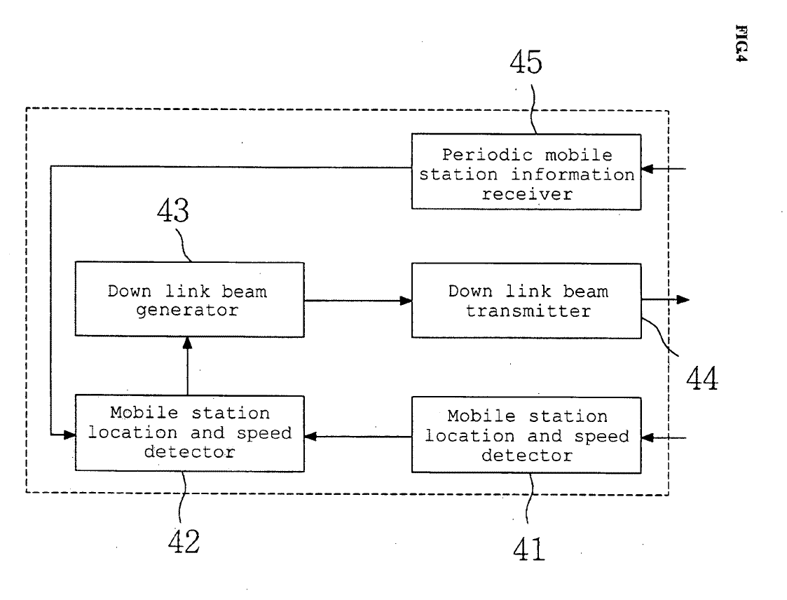

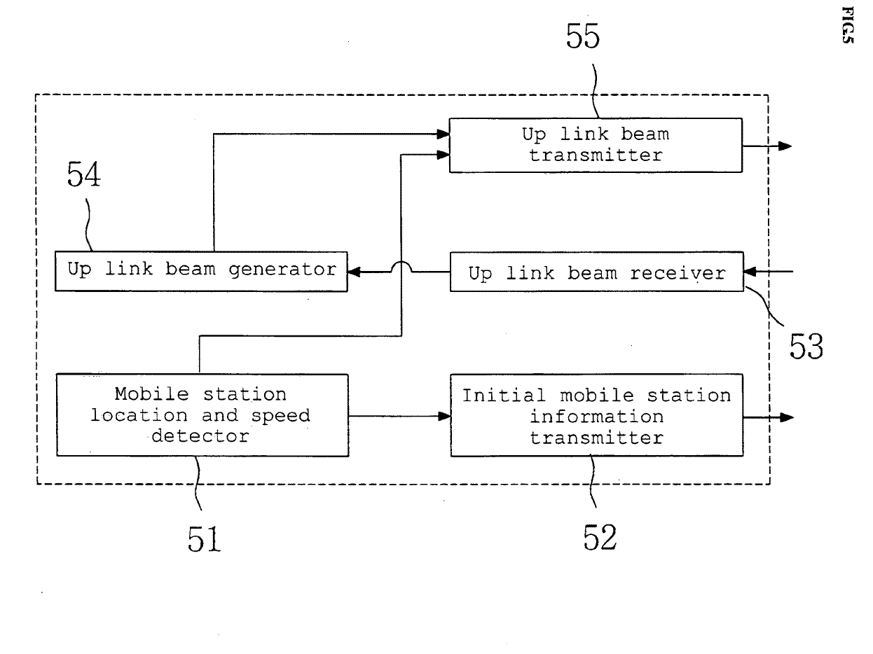

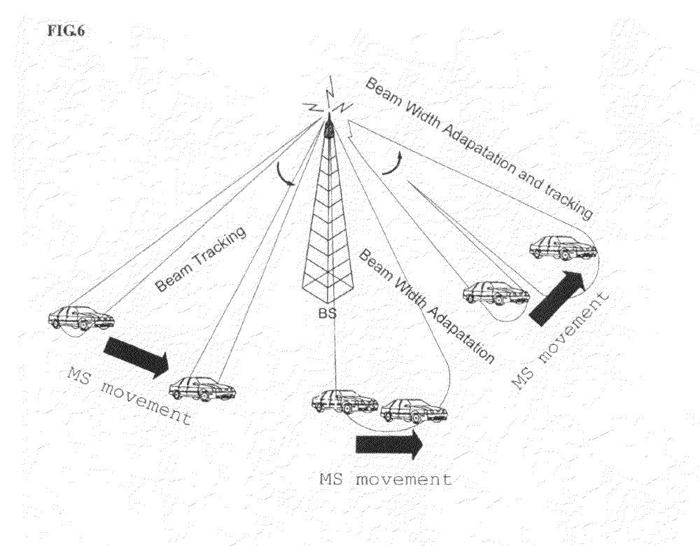

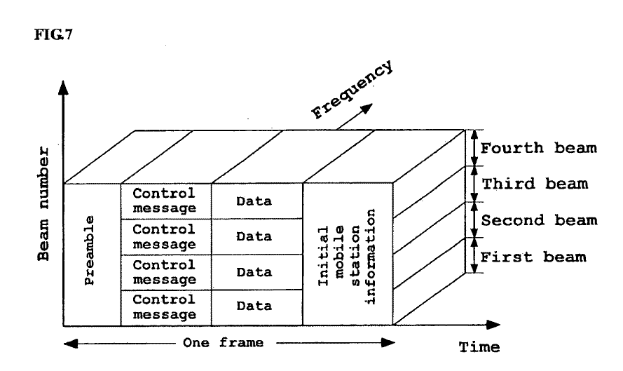

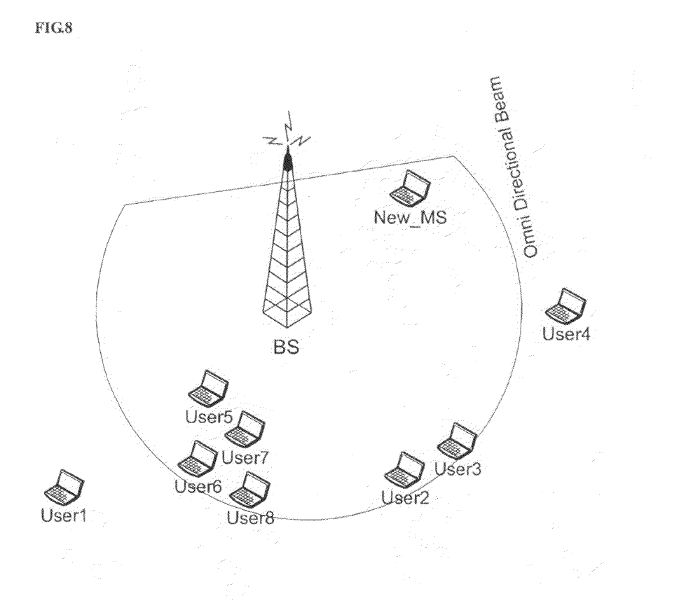

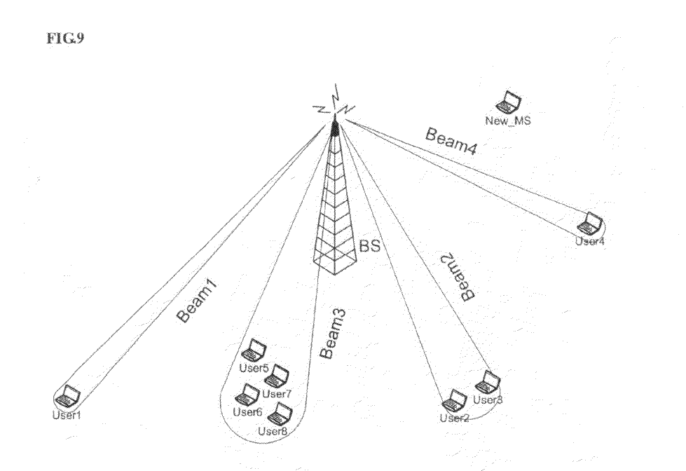

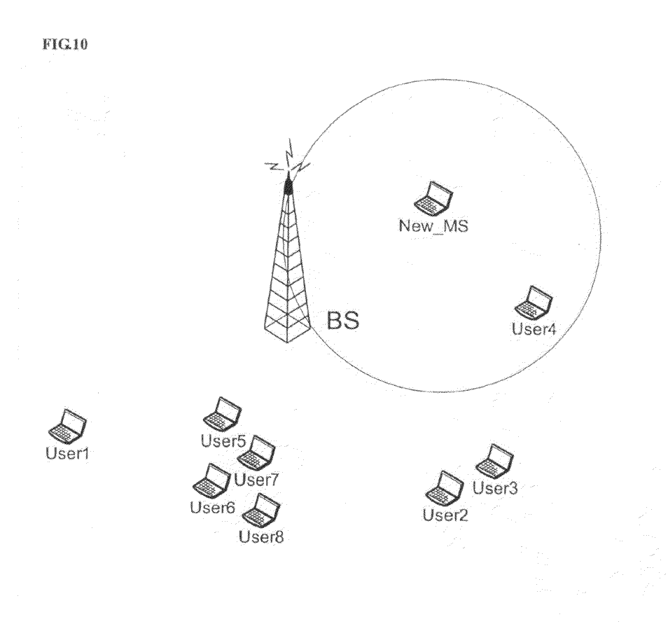

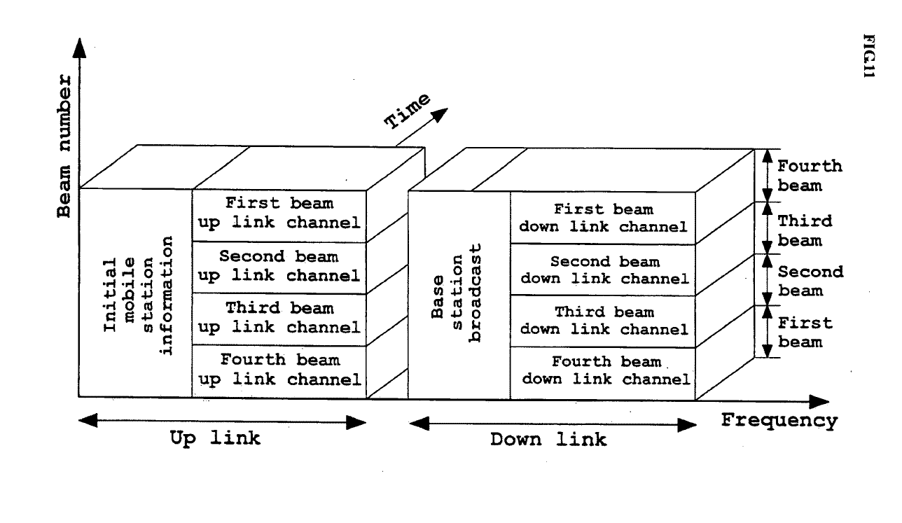

FIG. 3 is a timing diagram between a base station system and mobile stations which embody a BDMA technique of the present invention.

First, in an initial communication step, because a base station and mobile stations do not know each other's positions, the mobile stations detect their positions and moving speeds (step S31), and omnidirectionally transmit the detected positions and moving speeds information thereof to the base station (step 532). At this time, prior to transmitting the detected positions and moving speeds information, the mobile station receives preamble information from a frame structure that the base station omnidirectionally transmits, and obtains base station information based on the preamble information, and then transmits position and moving speed information of the mobile station to a corresponding base station.

Next, the base station calculates a direction and a width of a downlink beam based on the position and moving speed information of the mobile station received from the mobile station (step S33). Subsequently, the base station transmits the downlink beam to the mobile station with the calculated direction and width (step S34). When the mobile station receives the calculated direction and width of the downlink beam, it tracks a direction of the downlink beam to set a direction of an uplink beam (step 535), and transmits the uplink beam in the set direction (step S36).

After the mobile station sets the uplink beam, a beam update is periodically performed between the mobile station and the base station. Accordingly, the mobile station periodically reports its location and moving speed information to the base station. The base station adjusts a direction and a width of a beam based on the location and moving speed information of the mobile station to adaptively respond to a motion of the mobile station.

FIG. 4 is a block diagram showing a configuration of a base station system for embodying the BMA technique according to the present invention.

With reference to FIG. 4, the base station system comprises an initial mobile station information receiver 41, a mobile station location and speed detector 42, a downlink beam generator 43, a downlink beam transmitter 44, and a periodic mobile station information receiver 45.

The initial mobile station information receiver 41 receives initial mobile station information that a mobile station omnidirectionally transmits in an initial communication step, and transfers the received initial mobile station information to the mobile station location and speed detector 42.

The mobile station location and speed detector 42 detects and transfers a location and a moving speed of the mobile station from the initial mobile station information, to the downlink beam generator 43. Further, the mobile station location and speed detector 42 can detect the location and the moving speed of the mobile station from periodic information of the mobile station transferred from the periodic mobile station information receiver 45, and transfers it to the downlink beam generator 43.

The downlink beam generator 43 generates a downlink beam based on the location and the moving speed of the mobile station transferred from the mobile station location and speed detector 42. Further, the downlink beam generator 43 adjusts at least one of a width and a direction of each downlink beam, and transfers the adjusted width or direction thereof to the downlink beam transmitter 44.

The downlink beam transmitter 44 transmits the downlink beam received from the downlink beam generator 43 to the mobile station through a phase array antenna.

After the downlink beam and the uplink beam are set between the base station and the mobile station, the mobile station periodically detects its location and speed, and transfers them to the base station as periodic information. Such a function can be performed when the periodic mobile station information receiver 45 receives and transfers the periodic information of the mobile station to the mobile station location and speed detector 42.

As a result, the downlink beam and the uplink beam can vary based on the periodic information of the mobile station, which is transferred between the base station and the mobile station in order to achieve a beam update.

FIG. 5 is a block diagram showing a construction of a mobile station for embodying the BDMA technique according to the present invention.

Referring to FIG. 5, the mobile station comprises a mobile station location and speed detector 51, an initial mobile station information transmitter 52, a downlink beam receiver 53, an uplink beam generator 54, an uplink beam generator 54, and an uplink beam transmitter 55.

The mobile station location and speed detector detects and transfers a current location and moving speed of a mobile station using a GPS (Global Positioning System) or other equipment, to the initial mobile station information transmitter 52 and the uplink beam transmitter 55.

Since the initial mobile station information transmitter 52 does not know a location of a base station, it omnidirectionally transmits initial mobile station information comprising the current location and moving speed of the mobile station to the base station.

The downlink beam receiver 53 receives a downlink beam from the base station.

The uplink beam generator 54 tracks a direction of the downlink beam received by the downlink beam receiver 53, and generates and transfers an uplink beam to the uplink beam transmitter 55.

The uplink beam transmitter 55 transmits the uplink beam generated by the uplink beam generator 54 to the base station. The uplink beam transmitter 55 transmits the current location and moving speed of the mobile station detected by the mobile station location and speed detector 51 to the base station as periodic information, with the result that a downlink beam and an uplink beam can be updated according to the position and moving speed of the mobile station.

In the present invention, after an initial downlink and an initial uplink are set based on current location and moving speed information, a beam update is performed. As the beam update method, the present invention uses one of a Beam Width Adaptation (referred to as ‘BWA’ hereinafter), a Beam Tracking (referred to as ‘BT’ hereinafter), and a Beam Width Adaptation and Tracking (referred to as ‘BWAT’ hereinafter), which is a combination thereof.

FIG. 6 illustrates an applied example of the beam update method according to the present invention.

The BWA adjusts a beam width according to a moving speed of a mobile station to support the mobility of the mobile station. In the BWA, when the moving speed of the mobile station is high, a wider beam width is allotted. When the moving speed of the mobile station is low, a narrower beam width is allotted. Accordingly, although the base station does not know an exact location of the mobile station during a movement of the mobile station, the base station can continue to support communication services. For this purpose, the BWA according to the present invention is advantageous in that it needs only a small amount of feedback information for location and moving speed of the mobile station.

The BT is a method, which adjusts a direction of a beam according to a movement of a mobile station. The BT has a disadvantage in that it should feedback exact location information of the mobile station to a base station each time the mobile station moves. However, the BT is advantageous in that a beam management is easy because a beam width is constant.

The BWAT has advantages of the BWA and the BT in that it can adjust a width and a direction of a beam according to a moving speed of a mobile station, as a combination method thereof.

In the conventional mobile communication system, a frame structure considering a beam division is not defined. Accordingly, so as to apply the BDMA method of the present invention to a mobile communication system, there is a need to define a new frame structure considering the beam division.

A frame for a BDMA according to the present invention allots a resource, in three dimension which consists of a beam axis, a time axis and a frequency axis. A frame for supporting the BDMA of the present invention is different depending on whether a used duplexing is a Time Division Duplexing (referred to as ‘TDD’) or a Frequency Division Duplexing (referred to as ‘FDD’).

FIG. 7 illustrates a frame structure for supporting a TDD-BDMA according to the present invention.

The frame for the TDD BDMA shown in FIG. 7 allots a resource with a frequency axis, a time axis, and a beam number axis, and is divided into a part for transmitting an omnidirectional signal and a part for transmitting the signal using an orthogonal beam.

There are a preamble recording information that all mobile stations in a cell should simultaneously receive, and an initial mobile station information slot feed backing location and speed information of a mobile station so that the mobile station initially communicates with a base station. A real control message and data transferred between the base station and the mobile station are transmitted by beams using the same frequency/time resources. In a frame, uplink frame begins after downlink frame ends to minimize the number of the up/down transmission changes.

FIG. 8 to FIG. 10 illustrate applied examples of the TDD-BDMA frame of FIG. 7.

FIG. 8 shows a procedure in which a base station transmits an omnidirectional preamble.

A preamble that mobile stations in a cell should simultaneously receive is omnidirectionally transmitted in a preamble slot of the TDD-BDMA frame. All the MSs which include a first user to an eighth user, and a new mobile station New_MS receive the same preamble from the base station. Respective mobile stations acquire basic information of the base station and synchronize with the base station using the preamble.

FIG. 9 shows a communication between the base station and mobile stations with an orthogonal beam.

The base station communicates with mobile stations. An orthogonal beam is allocated to each mobile station. In the applied example of FIG. 9, a first user communicates with the base station using a first beam, a second user and a third user communicate with the base station using a second beam. Further, fifth to eighth users communicate with the base station using a third beam, and a fourth user communicates with the base station using a fourth beam.

The beams used in such a BDMA have very high directional characteristics so as to maintain orthogonality between beams, causing a minute negligible interference each other.

A mobile station reporting initial information thereof through an initial mobile station information slot, receives allotment of a downlink beam from a base station, and tracks a direction of the downlink beam, to thereby determine a direction for an uplink beam. Since the base station does not know a location of a new mobile station New_MS yet, it cannot allot a beam to the new mobile station.

FIG. 10 illustrates a procedure in which a mobile station transmits initial mobile station information to a base station. The new mobile station, to which a beam from the base station was not allotted, provides its location and speed information to the base station through an initial mobile station information slot. The new mobile station New_MS of FIG. 10 provides its location to the base station through the initial mobile station information slot to receive the allotment of a beam in a next frame.

FIG. 11 illustrates a view showing a frame structure for supporting an FDD-BDMA according to the present invention.

The FDD-BDMA frame is almost the same as that of the TDD-BDMA. The difference is that the initial mobile station information slot is allocated by dividing a frequency resource, and not by dividing a time resource. A further difference is that there is a base station broadcast in the FDD-BDMA instead of a preamble of the TDD-BDMA. The mobile station acquires basic information of the base station and synchronizes with the base station using a frequency band of the base station broadcast.

Namely, unlike in the TDD-BDMA, the mobile station in the FDD-BDMA acquires the basic information of the base station and synchronizes with the base station using the base station broadcast. Next, the mobile stations transmit data using beams allotted to respective mobile stations, and report their location and speed information to the base station using the initial mobile station information slot.

Although a few embodiments of the present invention have been shown and described, it would be appreciated by those skilled in the art that changes might be made in this embodiment without departing from the principles and spirit of the invention, the scope of which is defined in the claims and their equivalents.

The present invention is applicable to a design of cellular wireless communication systems for the next generation.

1. A beam division multiple access system in a base station of a mobile communication system, comprising:
an initial mobile station information receiver for receiving initial mobile station information that a mobile station omnidirectionally transmits in an initial communication step;
a mobile station location and speed detector for detecting a location and a moving speed of the mobile station from the initial mobile station information of the initial mobile station information receiver;
a downlink beam generator for generating a downlink beam based on the location and the moving speed of the mobile station transferred from the mobile station location and speed detector, and adjusting at least one of a width and a direction of each the downlink beam; and
a downlink beam transmitter for transmitting the downlink beam generated by the downlink beam generator to the mobile station through a phase array antenna.

2. The beam division multiple access system in a base station of a mobile communication system of claim 1, further comprising a periodic mobile station information receiver for receiving and transferring periodic information in which the mobile station transmits during a beam division multiple-access communication between the base station and the mobile station, to the mobile station location and speed detector.

3. The beam division multiple access system in a base station of a mobile communication system of claim 2, wherein the downlink beam generator adjusts a width of the downlink beam when the mobile station moves.

4. The beam division multiple access system in a base station of a mobile communication system of claim 2, wherein the downlink beam generator adjusts a direction of the downlink beam when the mobile station moves.

5. The beam division multiple access system in a base station of a mobile communication system of claim 2, wherein the downlink beam generator adjusts a width and a direction of the downlink beam when the mobile station moves.

6. A beam division multiple access system in a mobile station of a mobile communication system, comprising:
a mobile station location and speed detector for detecting a current location and moving speed of a mobile station;
an initial mobile station information transmitter for omnidirectionally transmitting initial mobile station information comprising the current location and moving speed of the mobile station to a base station;
a downlink beam receiver for receiving a downlink beam from the base station;
an uplink beam generator for tracking a direction of the downlink beam received by the downlink beam receiver and generating an uplink beam; and
an uplink beam transmitter for transmitting the uplink beam generated by the uplink beam generator to the base station.

7. The beam division multiple access system in a mobile station of a mobile communication system of claim 6, wherein the uplink beam transmitter periodically transmits the current location and moving speed of the mobile station detected by the mobile station location and speed detector to the base station.

8. The beam division multiple access system in a mobile station of a mobile communication system of claim 6, wherein at least two of the mobile stations using the same beam for give multiple-access to the base station.

9. A beam division multiple access method in a base station of a mobile communication system, comprising the steps of:
(a) receiving initial mobile station information that a mobile station omnidirectionally transmits in an initial communication step;
(b) detecting a location and a moving speed of the mobile station from the initial mobile station information received in the step (a);
(c) generating a downlink beam based on the location and the moving speed of the mobile station detected in the step (b), and adjusting at least one of a width and a direction of each the downlink beam; and
(d) transmitting the downlink beam generated in the step (c) to the mobile station through a phase array antenna.

10. The beam division multiple access method in a base station of a mobile communication system of claim 9, further comprising the step of receiving and transferring periodic information in which the mobile station transmits during a beam division multiple-access communication between the base station and the mobile station, to the step (b).

11. The beam division multiple access method in a base station of a mobile communication system of claim 10, wherein the step (c) adjusts a width of the downlink beam when the mobile station moves.

12. The beam division multiple access method in a base station of a mobile communication system of claim 10, wherein the step (c) adjusts a direction of the downlink beam when the mobile station moves.

13. The beam division multiple access method in a base station of a mobile communication system of claim 10, wherein the step (c) adjusts a width and a direction of the downlink beam when the mobile station moves.

14. A beam division multiple access method in a mobile station of a mobile communication system, comprising the steps of:
(a) detecting a current location and moving speed of a mobile station;
(b) omnidirectionally transmitting initial mobile station information comprising the current location and moving speed of the mobile station to a base station;
(c) receiving a downlink beam from the base station;
(d) tracking a direction of the downlink beam received in the step (c) and generating an uplink beam; and
(e) transmitting the uplink beam generated in the step (d) to the base station.

15. The beam division multiple access method in a mobile station of a mobile communication system of claim 14, wherein the step (e) periodically transmits the current location and moving speed of the mobile station detected in the step (a) to the base station.

16. The beam division multiple access method in a mobile station of a mobile communication system of claim 14, wherein at least two of the mobile stations using the same beam give multiple-access to the base station.
